(19) United States
(12) Patent Application Publication
(10) Pub. No.: US 2004/0036722 A1
(43) Pub. Date: Feb. 26, 2004

(54) Configurable type-over text box prompt

(76) Inventor: Peter Warren, Chattanooga, TN (US)

Correspondence Address: GREENBERG-TRAURIG, 1750 TYSONS BOULEVARD, 12TH FLOOR, MCLEAN, VA, 22102, US

(21) Appl. No.: 10/227,410

(22) Filed: Aug. 26, 2002

(51) Int. Cl. G09G 5/00

(52) U.S. Cl. 345/866; 345/780; 345/809; 345/762

(57) ABSTRACT

A method for receiving data through a user interface displaying a text box with a type-over prompt displayed inside the text box. To customize the user interface, multiple users may each define, save and access multiple views of the interface in which the text box is customized to display user-defined prompts as the type-over prompt. A view selection utility allows each user to select which view to display when activating the user interface so that the user may select among a variety of views containing different user-defined type-over text prompts. The user may also select a default view including the pre-configured type-over text prompt installed with the software.

### REFERENCED TO RELATED APPLICATIONS

This application claims the benefit of commonly-owned U.S. patent application Ser. No. 09/712,581 entitled “Any-To-Any Component Computing System” and commonly-owned U.S. patent application Ser. No. 09/710,826 entitled “Graphical User Interface,” the entire disclosures of which are incorporated herein by reference.

This application is related to U.S. patent applications entitled “DYNAMIC DATA ITEM VIEWER”, “STRUCTURED FORMS WITH CONFIGURABLE LABELS”, and “MULTI-LEVEL USER HELP” filed Aug. 26, 2002 by inventors Peter Warren et al., the entire disclosures of which, including the technical letters incorporated therein, are incorporated herein by reference.

### TECHNICAL FIELD

This invention relates to computer software and, more specifically, relates to a graphical user interface for a computer system including a user input screen containing a text box with a type-over prompt displayed inside the text box in which multiple users may each define, save and access multiple views of the user input screen including customized messages for the type-over prompt.

### BACKGROUND OF THE INVENTION

The capabilities of software constructed with conventional approaches are inherently limited due to the fundamental nature in which the software is constructed. In particular, virtually every type of conventional software is constructed as one or more large masses of executable code that is written in one or more source code files, which are compiled into one or more executable files, which typically produce interrelated output data of various types. The format of the output data, and the screen displays rendered by the software for showing the output data, are integrally controlled and set up by the executable code, which may further involve integral cooperation with facilities provided by the operating system and other applications, such as commonly-accessed objects, DLLs, device drivers, and the like. Once compiled, the executable files can run on an appropriately equipped computer system to implement the pre-configured functionality and render the pre-configured output screens. But the resulting software infrastructure is inherently limited because it is very difficult to vary software constructed in this manner from the pre-configured functionality originally built into the software. This is a systemic problem with the conventional software infrastructure, which currently limits the ability of this infrastructure to progress in an evolutionary manner.

Specifically, once a particular application has been written and compiled in the conventional manner, the functionality of the application is inherently limited to the functions that the developers anticipated and built into the executable files. Any change to the pre-configured code, or the data structures, or the visual output capability, requires digging into the original source code, writing programming changes at the source code level, debugging and testing the altered code, and recompiling the altered code. Once this task has been completed, the software application is again limited to the functionality that the developers anticipated and built into the updated executable files. But the updated executable files are just as inaccessible to the user as the original files, which again limits the functionality of the software to the functionality built into the newly updated executable files.

As any software engineer can attest, the process of updating conventional software in the manner described above becomes increasingly difficult as the software becomes increasingly sophisticated. Even conceptually simple tasks, such as implementing software changes while maintaining backward compatibility with files created using earlier versions of the same software, can become vexingly difficult and in some cases technically impractical or economically infeasible. Indeed, the “Y2K” programming challenge taught the industry that implementing any type of programming change to conventional software, no matter how conceptually simple, can draw the programmers into a nearly impenetrable morass of interrelated instructions and data structures expressed in a complex system of executable files that typically cannot share information or functional capabilities with each other without tremendous effort.

In general, this programming inflexibility ultimately results in limitations imposed on the sophistication of software, limitations imposed on the ability to integrate existing applications together into cooperating units, and limitations imposed on the scope of potential users who can effectively use virtually any type of software built using the current infrastructure. As a result, much of the world remains computer illiterate, while the remainder struggles to deal with the current system, which includes a staggering number of enormously complex executable files. In addition, recent increases in computer hardware capabilities remain substantially underutilized because conventional software cannot effectively be extended to take advantage of the new computing capabilities. The end results include hardware and software industries that both appear to be stymied, waiting for a solution that will allow significant progress to proceed on both fronts.

From a more personal point of view, the conventional software infrastructure effectively shifts serious burdens from the software (or, more correctly, from the programmers who wrote the software) onto those persons least equipped to deal with them, such as new users trying to learn how to use the programs. This occurs because the programmers must necessarily develop a system of documentation to assist the users in understanding how to use the software, which is an expensive undertaking that generally increases with the amount of documentation provided. The most expedient approach often involves creating the least amount of documentation that one can reasonably be expected to get away with in the current market, and letting the users “fend for themselves” or buy a different product.

For example, one type of help documentation includes pop-up user interface screens that display text-based help items “on the fly” under the control of the underlying software. However, due the limited size of the display screen, the amount of information that can be communicated in this manner is very limited. This limitation is exacerbated when the display screen is very small, as occurs with hand-held PDA devices, wireless telephones, and the like. In addition, too many help screens that pop-up automatically without user control can be an annoying impediment. Although menu-driven help screens can decrease the reliance on automatic pop-up screens, they can be cumbersome and time consuming to use. To make matters worse, the prevailing market forces apparently dictate that inexpensive small-screen computing devices come with the thinnest, most puzzling types of printed and on-screen documentation. In sum, the shortcomings of conventional help documentation appear to present a formidable near-term barrier to bringing inexpensive small-screen computing devices to much of the computer-illiterate world. Unfortunately, this condition may significantly delay the realization of very widespread distribution of inexpensive computing devices with the capacity to bridge the technology gap that currently separates the computer “haves” from the computer “have-nots.”

Moreover, because the same automatic user interface screens are necessarily displayed for all users regardless of their familiarization with the software, these on-screen displays are usually limited to displays that “most” users find “most” helpful “most” of the time, which are all too often incomprehensible to the newcomer and inadequately specific for the expert. For more detailed information, the user must resort to other less obvious resources, such as menu-driven help documentation or printed manuals. In general, these resources are notoriously cryptic, and remain so despite the best intentions of many highly skilled authors. For example, although some of these resources are “context sensitive,” they may still be inadequately germane to a particular matter at hand, especially when that matter was not fully anticipated by the author of the documentation. Even when assisted by probability or other conventional mechanisms, these resources often miss the mark so badly as to be nearly useless—typically when the user needs them most. Partly as a result of these systemic limitations, new users are often intimidated from getting started with new software programs, and many sophisticated functions built into the software programs remain unused, even by long-time users.

Another important practical effect of the limitations experienced by conventional software appears when a user or developer would like to translate an application into a foreign language. Because much of the text displayed by the application is embedded within executable files, a commercially viable set of labels, prompts, messages and help screens cannot be translated into another language without digging into the source code, changing the text at this level, and then recompiling the code. For a sophisticated software application, this process can be extremely time consuming, expensive and difficult, and generally requires an expensive team of highly skilled programmers to complete. As a result, it is impractical or economically infeasible to translate many types of software into a very wide selection of languages that would ensure its greatest use. For this reason, many software applications remain limited to their original human language, and even when an application is translated, it is typically limited to the world's four or five most-used languages. This limits the markets for these products, which deprives much of the world from the benefits that it could enjoy from access to powerful software applications.

To illustrate another practical limitation of conventional software, consider an organizational environment in which part of a document, such as an accounting spreadsheet or briefing document, is required reading for certain employees while other parts of the document contain confidential information that is off-limits to those same employees. One attempted solution for this conundrum involves creating different versions of the same document suitable for distribution to different users. This approach immediately multiplies the complexity of document management and brings into play challenging problems, such as having to store multiple versions of the same document, having to keep multiple versions of the same document coordinated with a base version that changes continually, and so forth. If the document contains sophisticated code and large amounts of data, the resources required to store and maintain duplicate copies can be a significant factor.

Moreover, regardless of the resource requirements, the administrative difficulties can become extreme when the objective is to make extremely sensitive information available in accordance with an intricate system of access rules. Common examples of these types of applications include financial accounting systems and security clearance-based access systems. In these situations, the only cost effective way to ensure an adequate level of confidentiality may be to implement a document management system that prevents all of the software, or all of its data, from being accessed by anyone except a very limited number of “authorized” persons. At the same time, however, it would be far more efficient if appropriate portions of the application could be freely accessed by a variety of “non-authorized” or “partially-authorized” persons.

In the current state of the art, an additional conundrum occurs when different persons in an organization need to be able to do different things to a particular type of data. For example, several different persons may have a need to perform different activities using a particular type of data. Prior attempts to solve this problem include the development of commonly-accessed spreadsheets, in which certain cells of the spreadsheet, or the entire spreadsheet, can be “locked” and only accessible via a password. Unfortunately, this type of functionality is not generally available to the users of other application programs, such as word processing, presentation software, database software, and the like. Moreover, even in the spreadsheet programs containing this type of functionality, the solution has thus far been so inflexible that the ability to make changes to a particular spreadsheet is either black or white. That is, the only available choices are to allow a particular user to change all the data and functions in the spreadsheet, or to make that user unable to input any changes at all.

To make matters worse, it is very difficult to resolve this problem in current software programs because the inability of these programs to make data and functionality available on a user-by-user or item-by-item basis is deeply rooted in the programs at the source code level, and therefore has little or nothing to do with the type or sensitivity of the data produced or maintained by the software. As an example of this problem, consider a briefing document that contains some confidential parts and other non-confidential parts suitable for public consumption. In this example, the organization controlling the document may want its staff to read the entire briefing, but does not want any of the confidential parts to be sent to outsiders. At the same time, the organization may have a policy the permits outsiders to read the non-confidential parts of the document, for example in response to a valid Freedom of Information Act request. Typically, a word processing program or an e-mail program can either send out everything it can access, or can't send out anything. Hence, if an employee reads such a document using his word-processing software, he can also send it out by e-mail, which can undermine attempts to control subsequent distribution of the document and lead to considerable embarrassment for those concerned.

This problem occurs because conventional software is limited in that it cannot make individual elements of data or functionality available, or unavailable, on a user-by-user or item-by-item basis. For example, in the situation discussed above, a particular briefing created for public consumption cannot contain any confidential data, while a briefing on the same subject matter containing a relatively small amount of confidential information must be restricted to a small class of authorized persons. In very high-security environments, the only practical way to deal with this problem may be to create an “air-wall” in which the internal system has no connection to the outside world whatsoever, which causes additional problems including inefficiencies at the human level.

Despite an enormously expensive training and support infrastructure that has developed around the conventional software industry, the promise of increasingly sophisticated software remains constrained by steep learning curves, ineffective documentation, inadequate and overly expensive training options and long and expensive deployment cycles. Consider again the accounting example in which a salesman should certainly be able to see if his client's payment has arrived, but he cannot because he is not fully “authorized.” The root cause of this problem lies in the inflexibility of the underlying software, and the only practical alternative to fixing the software effectively shifts the cost of the problem onto the humans involved, in this example by requiring the salesman to expend considerable time “talking to the accounts department” to obtain data that ought to be freely available to him in the first place. Not only does this so-called solution waste the salesman's time, it also disturbs at least one other person working in the accounts department. Eventually, entire job descriptions center around tasks created by software programs. Put somewhat differently, the current software infrastructure shifts very significant burdens onto the humans involved, rather than the other way around, which is serious problem indeed.

Therefore, a need exists for an improved paradigm for constructing software that overcomes the inherent limitations of the conventional software infrastructure. A further need exists for improved methods for controlling the exposure of data and functionality of software on a user-by-user and item-by-item basis. And a further need exists for incorporating helpful instructional capabilities into software that can be effectively targeted to particular matters that confront users of all skill levels.

### SUMMARY OF THE INVENTION

The present invention meets the needs described above in a method for receiving, displaying and otherwise using data through a user interface displaying a text box with a type-over prompt displayed inside the text box that can both increase ease of understanding of displayed items and can economize screen space, at the same time rendering it easy to make this aspects multi-lingual. The invention may be implemented on a host computer system or stored on a computer storage medium. To customize the user interface, multiple users may each define, save and access multiple views of the interface in multiple languages, in which the text box is customized to display user-defined prompts as the type-over prompt. A view selection utility allows each user to select which view to display when activating the user interface so that the user may select among a variety of views containing different user-defined type-over text prompts. The user may also select a default view including the pre-configured type-over text prompt installed with the software.

The text box including a type-over text prompt saves screen space by displaying the type-over prompt inside the text box. This is an important advantage for busy data screens, and an especially important advantage for very small screens such as those included on personal digital assistants, wireless telephones and the like. This advantage arises because, while one obviously needs to know what data should be entered in a data entry field, once data is so entered, or when data is so entered, what the displayed or entered data is, becomes self evident and hence, does not then require additional screen space in which a label is displayed, for example. If a text box shows “John Doe” for example, no-one needs a label to say that this is a first name and a last name of a person, and hence, the label for such a text box can be dispensed with entirely, with consequent saving in screen space. While it is not always possible to dispense with a label, the duty of the label can in such cases often done by pop-up help. Between such mechanisms, a label is rarely necessary, and it is then possible to construct restricted area mobile screen entirely, or almost entirely from data entry and display areas, considerably augmenting the effective area of the screen. The configurable nature of the type-over text prompt allows the user to redefine the type-over prompt to facilitate any number of objectives. For example, the user can easily translate the type-over prompts of a particular user interface into any or many of the world's 200+ languages, define different sets of type-over prompts for training exercises, create descriptive type-over prompts for special purpose interfaces, and so forth.

Further, the type-over text boxes may be customized, as described above, during an uninterrupted user session. In the context of the invention, the term “uninterrupted user session” means that the host system performs the type-over text box modification “on the fly” during a continuous and substantially uninterrupted user session. For example, the host system performs type-over text boxes modification without having to interrupt the user session to recompile the underlying code, reboot the system, or restart the application implementing the method. Thus, multiple users may define, store and access multiple views of type-over text box prompts “on the fly,” which greatly improves the capabilities and understandability of any application using text boxes. In particular, any user may define, store and access multiple views of type-over text prompts “on the fly” to create customized platforms for a virtually unlimited range of purposes, such as implementing language translation, creating training platforms, customizing data views for special purposes, customizing data views for other persons, and so forth.

Generally described, the invention includes a method for receiving data through a user interface, which may be implemented on a host computer. The host computer displays a text box with a pre-configured prompt displayed within the text box. The host computer then receives user input defining a data entry. From the moment data entry is started, this data entry replaces the prompt within the text box, which the host computer saves as a text box response in a database, and, should the data subsequently be removed, for example by deleting the entered text, then the prompt re-appears as soon as the last part of the data entered is removed. While such a mechanism has occurred and been used under isolated circumstances such as in presentation programs in which it occurs as a result of code incorporated in the executable and consequently cannot be changed by the user on the fly, the mechanism described here is both more flexible in that the type over text prompt is also user-configurable and, when, for example constructed in a database or an Exobrain is universally applicable to every single data item even one such as a database where the user-selectable multi-lingual ability becomes very important) or to a spreadsheet. In addition, the host computer may receive user input defining a user-defined prompt. This user-defined prompt replaces the pre-configured prompt within the text box. The host computer then receives user input defining a data entry. In this case, the data entry replaces the user-defined prompt within the text box; and the host computer saves the data entry as a text box response in the database.

The host computer may also receive user input defining a user-defined view name associated with the user-defined prompt. The host computer then stores the user-defined prompt in the database in association with the user-defined view name. This allows the host computer to display a view selection utility including the user-defined view name and a default view name associated with the pre-configured prompt. The view selection utility allows the host computer to receive a first user command selecting the user-defined view name. The host computer then responds by displaying the text box with the user-defined prompt displayed within the text box. The view selection utility allows the host computer to receive a second user command selecting the default view name. The host computer then responds by displaying the text box with the pre-configured prompt displayed within the text box.

To automatically initiate a text box view created by a user, when the host computer receives a user input activating a user display comprising a text box, the host computer determines whether a user-defined prompt has been previously defined for the text box. If a user-defined prompt has been previously defined for the text box, the host computer displays the text box with the user-defined prompt displayed within the text box. Alternatively, if a user-defined prompt has not been previously defined for the text box, the host computer displays the text box with a pre-configured prompt displayed within the text box.

To automatically initiate text box views created by multiple users, the host computer may initially display a pre-configured prompt within the text box. The host computer may then receive input from a first user defining a first user-defined prompt and store the first user-defined prompt. The host computer may then receive input from a second user defining a second user-defined prompt and store the second user-defined prompt. Then, in response to receiving a command from the first user activating the text box, the host computer displays the text box with the first user-defined prompt displayed within the text box. Alternatively, in response to receiving a command from the second user activating the text box, the host computer displays the text box with the second user-defined prompt displayed within the text box. For a user that has not created a user-defined view, the host computer may receive a command from a third user activating the text box and determine that the third user has not defined a user-defined prompt for the text box. In this case, the host computer displays the text box with the pre-configured prompt displayed within the text box, which may also be referred to as the default prompt. To allow any user to select the default prompt, the host computer may display the view selection utility including the user-defined view names associated with the user defined views and a default view name associated with the pre-configured prompt.

To allow different users to access the views that they created, the host computer may initially display a pre-configured prompt within the text box and then receive input defining a first user-defined prompt. The host computer may also receive input defining a first view name associated with the first user-defined prompt, and store the first user-defined prompt in association with the first view name. The host computer may also receive input defining a second user-defined prompt and input defining a second view name associated with the second user-defined prompt. The host computer then stores the second user-defined prompt in the database in association with the second view name. This allows the host computer to receive a command activating the text box and display a view selection utility including the first and second user-defined view names. The host computer may then receive a command selecting the first view name and display the text box with the first user-defined prompt displayed within the text box. Of course, the host computer may also receive a command selecting the second view name, and display the text box with the second user-defined prompt displayed within the text box. And as noted above, the view selection utility may display a default view name associated with the pre-configured prompt and receive a command selecting the default view name. In response, the host computer displays the text box with the pre-configured prompt displayed within the text box. Equally, matters may be so arranged that the user who is operating at the time is recorded in the host computer and hence, when the computer receives a command activating the application in which the text box is contained, may, at the users choice, either present the particular view and therefore prompt that the user last used, or always present a particular view for that user.

In view of the foregoing, it will be appreciated that the present invention avoids the drawbacks of conventional text box graphical user input screens and provides a more effective and flexible method for using text boxes to receive data from a computer user. The specific techniques and structures employed by the invention to improve over the drawbacks of prior systems for receiving data through text boxes in a computer environment and accomplish the advantages described above will become apparent from the following detailed description of the embodiments of the invention and the appended drawings and claims.

### BRIEF DESCRIPTION OF THE DRAWINGS

FIG. 1 is a functional block diagram of an EXOBRAIN system in which the present application may be implemented.

FIG. 2 is a user interface display illustrating text boxes containing pre-configured type-over prompts displayed within the text boxes.

FIG. 3 is a user interface display illustrating the receipt of data entries through text boxes containing pre-configured type-over prompts.

FIG. 4 is a user interface display illustrating saving data entries received through text boxes containing pre-configured type-over prompts.

FIG. 5 is a block diagram illustrating an address book created by saving data entries received through text boxes containing pre-configured type-over prompts.

FIG. 6 is a user interface display illustrating text boxes containing user-defined type-over prompts displayed within the text boxes.

FIG. 7 is a user interface display illustrating saving a view of an interface containing user-defined type-over prompts.

FIG. 8 is a block diagram illustrating a section of an address book created by saving data entries received through text boxes containing user-defined type-over prompts.

FIG. 9 is a block diagram illustrating an address book created by saving data entries received through text boxes containing user-defined type-over prompts.

FIG. 10 is a user interface display illustrating a view selection utility for selecting among views of a text box user interface containing different user-defined type-over prompts.

FIG. 11 is a block diagram illustrating multiple view selection utilities allowing different users to select among views of a text box user interface that they created containing different user-defined type-over prompts.

### DETAILED DESCRIPTION OF THE EMBODIMENTS

The present invention includes a dynamic item manipulator that may be embodied in applications constructed using a new software paradigm known as an EXOBRAIN™ system. This trademark, which is owned by ExoBrain, Inc. of Chattanooga, Tenn., refers to an any-to-any component computing system as described in U.S. patent application Ser. No. 09/712,581, and a related graphical user interface as described in U.S. patent application Ser. No. 09/710,826, which are incorporated by reference. This system is further described in the technical letters appended to the co-pending application of Peter Warren entitled “Dynamic Data Item Viewer” filed Aug. 26, 2002, which are also incorporated by reference. The technical letters include a descriptive table illustrating the structure and functionality of a data relation table (DRT) along with several text files describing the construction and use of the DRT in implementing an EXOBRAIN system. It is important to appreciate that in an any-to-any machine, every type of data item, even one as elemental as a single letter, may be represented in fields contained in the DRT. While this aspect of the embodiments described below facilitates the implementation of the invention, this does not in any way limit the scope of this invention to an any-to-any machine.

The embodiments of the invention may be implemented on a host computer system, which may be local or remote, or they may be expressed in computer-executable instructions stored on any suitable type of computer storage medium. In this context, a “host computer system” refers either to a local computer at which a person is working, or to a remote computer that stores the data, stores the software, stores the input/output control information, controls the local system, or performs some other function involved in the implementation of the methodology, or to combinations thereof. In particular, the claimed invention should be considered to have been practiced wherever the benefit of the invention is enjoyed, regardless of whether one or more of the constituent steps or devices were performed or located in a jurisdiction in which the invention is not patented, such as outer space, a country without a patent system, or a country where patent protection has not been secured. Similarly, the claimed invention should be considered to have been practiced wherever a substantial portion of the constituent steps or devices were performed or located, regardless of whether the totality of the claimed steps or devices were performed or located in multiple jurisdictions having disparate patent laws. Notwithstanding this potential computing environment complexity, the following minimum and recommend system requirements are presently considered appropriate for the basic functionality included in the current embodiments of the EXOBRAIN system: For a normal office application the minimum system requirements for EXOBRAIN implemented in Java are 200 MZ processor, 128 MB RAM, 5 GB disk. Recommended system is 1 GZ processor, 512 MB RAM, 10 GB disk. For Mobile applications the minimum system is 64 MB RAM, 256 MB of storage and a processor capable of running Linux.

In the context of the invention, a “view” is defined as a human perceptible representation of all or part of a data item and typically includes associated effects, such as an image, sound, animation, executable activity, or associated property. Thus, a view may include all of a particular data item or a combination of parts of that data item, and may include properties governing the appearance and functionality of the item. A view may include “pre-configured” elements defined prior to a current user session, and may also include “user-defined” elements defined during a current user session. Accordingly, the term “pre-configured” means data or functionality that was incorporated into a software structure prior to a current user session, either by prior programming or by prior user input creating user-defined data items using the tools and structures implemented by the prior programming. Moreover, the term “pre-configured” as applied to a data item also encompasses the null set, in which the pre-configured construct is a blank or empty item. In addition, the term “uninterrupted user session” means that the host computer system performs the recited method “on the fly” during a continuous and substantially uninterrupted user session without having to recompile the underlying code, reboot the system, restart the software, reload the view, or otherwise interrupt the user's interaction with the host computer system in a substantial way.

The customizable features of a view may include the selection of fields and functionality made available within a particular view, and may also include administration information controlling access to the items included on the view, such as the ability of users to view or change individual data items defined item-by-item, user-by-user, or on a group or global basis. The administration information may also include encryption, other security features, and other executable activities that may be defined field-by-field, item-by-item, user-by-user, or on a group or global basis. Further, the customizable features of a view may also include the selection of visual features associated with data items, such as borders, shapes, and backgrounds for view areas, as well as the selection of other effects, such as text features that may be displayed or played in connection with a data item, such as a label, prompt, message, tool tip, help item, and the like. In addition, the ability to access or make changes to a particular view, or to a constituent item of a view, or to any effect associated with a view or item within a view, are also administrative effects that can be defined field-by-field, view-by-view, item-by-item, effect-by-effect, user-by-user, or on a group or global basis.

In the context of a view, the term “effects” is used as catch-all term that includes administrative properties, as described above, as well as all types of features implemented within labels, prompts, help screens, tool tips, pop-up messages, and all other features that may be associated with a data item. For example, effects include all types of information conveyed from the host computer to the user through any form of user-detectable element of communication. Specifically, effects may include visual and audible items, such as text, images, animation, sound and executable activities that act to assist the user's understanding of the data, the software, other users, or some other relevant factor. For example, an effect may inform a user about data that he is expected to input or will receive as an output, or about a user or system that the user is communicating with, or about administration security features implemented in a view. An effect may be conveyed though visual and audible mechanisms, such as words, still or moving images, sounds, lines, arrows, boxes, or the like, such that the effect is to assist the user's understanding of the situation. Any of these items may include text in any font, size, color and style selected by the user, and may also include multi-media features such as images, sounds, animations, or executable activities that are performed in connection with the data item.

Effects may also involve executable activities and other features that may or may not be immediately apparent to the user, such as the execution of activities or the activation or deactivation of software functionality. For example, an effect may include the activation or deactivation of the ability to e-mail the item, the activation or deactivation of the ability to print the item, the execution of an activity performed by the view and displayed to the user, the execution of an activity executed in background, etc. By way of illustration, a view may be associated with an activity defined by the user to be automatically implemented upon selection of the view or an element of the view, such as a look-up and display activity, a link and display activity, a compute and display activity, or any other type of available activity defined by the user. In addition, multiple data items may be combined into a single view, and views may be shared, e-mailed, and exchanged with other users. This usefulness of this feature is further enhanced because a particular view or set of views can be exchanged with another user, who can receive, access and use the view during an uninterrupted session.

Although this invention is described in relation to visual input and output, the mechanisms described are not necessarily an inherent part of either the software that manipulates the data concerned or of the graphical user interface (GUI). Accordingly, the various software components and structures described herein may be implemented separately or in combination with each other. Further, the mechanisms described in this specification are equally applicable and able to control those of the described features applicable to non-visual input and outputs, such as tactile input and outputs, verbal input and output (such as text to speech and voice recognition), and to inputs and outputs between machines, and to any operative combination of these though further and obvious software mechanisms may be required to take advantage of the described abilities under those circumstances. Accordingly, where the word “display” is used in the description that follows, this should be interpreted in its broadest sense to include audio, visual and other human-detectable or machine-detectable modes of communication, as well as the acts of showing, playing, performing or executing any sort of data or instruction, or any combination or permutation of these.

It should also be understood that, although the following description explicitly concerns the example of altering a view containing pre-configured display items, the same techniques may be used to create such an item and its display in the first place. In view of this factor, the concept of a pre-configured display item encompasses the null set, in which the pre-configured construct is a blank or empty item. That is, the principles of the invention may be used to create the first and initial view of an item—effectively creating that new item type—as well as to alter previously created views. In addition, a pre-configured view may be constructed by programmers and included as part of the code supplied to a user, or they may be created or altered by users through the use of the functionality and structures included in the underlying programming. Nevertheless, it should be understood that all views, typically without exception, may be changed “on the fly” through user input. Thus, programmer-created views, and views created by non-programmer designers for a company commercializing software, are an optional, but not an essential, part of the product to be delivered to a user.

In addition, the host system, which may include local and remote components, stores the user-defined views for subsequent access, and displays the data items in association with the user-defined views, without the need for additional programming changes. This computing infrastructure is fundamentally different from today's software infrastructure, in which at least one view must be created by a programmer and rendered by the executable code. In addition, a default view is typically defined for a particular type of data item, and since the flexibility available has the capacity to allow the item to be distorted beyond recognition or use, typically, this default view (as well as any others) can by “locked” so that it cannot be removed or changed by an inexperienced or unauthorized person. However, the presence or absence of any particular data that is present in a particular view does not in any way affect the underlying data that may be there. Conventionally, and especially in existing database software, removing a field from visibility in a table can result in the loss of the data that had been stored in the removed. But this is not the case with the dynamic item manipulator, in which the view of the data—for example the selection of particular fields that is visible—has no effect on the existence or otherwise of the underlying data. In fact, it is also possible to arrange the system so that, within a given view, some parts of the data—for example, a particular selection of fields—is visible while another combination of fields that is not visible (but which may also include any of the visible fields) is being used to specify the data shown in the visible field selection. In conventional Query By Example (QBE) implementations, the fields used to query by an example are typically the same as the fields in which the result of the query is shown. In the dynamic item manipulator system, on the other hand, that limitation does not have to occur. For example, two or more different views of the data may be displayed simultaneously, one of which may be used as the QBE input, while the other view may display the results of the QBE query with the field selection or the targeted record type/s or both may be different in each.

Further, the host system may also display a user-accessible selection utility for selecting among the default view and other user-defined views. The host system then receives a selection command in association with the user-accessible selection utility indicating a selected view among the default and the user-defined views and, in response, displays the data item in association with the selected view. Of course, the user-accessible selection utility may itself be constructed as a user-configurable view in the manner described, and hence can be subject to the same customization flexibility that is applicable to any other view. For example, the user-accessible selection utility may itself be configured in the form of different views that the user can select, and the available views may be configured by the user to be suitable to the particular series of customizations he wishes to perform at the time. This is possible because the selection utility itself may be constructed in the form of data, the data in this case being the buttons that represent the various functionality it offers. The utility itself, or any view of data, can be switched to automatically display the utility or a view of particular data either with a view that is the view most recently accessed by the user or with a particular view no matter what view was last used.

The dynamic item manipulator may be implemented for one user, as described above, or it may be implemented for multiple users. That is, the host system may receive a first set of user commands associated with a first user defining a first user view for the data item, and store the first user view in association with an identifier corresponding to the first user. The host system may then receive a second set of user commands associated with a second user defining a second user view for the data item, and store the second user view in association with an identifier corresponding to the second user. The host system may also display a first user-accessible selection utility configured for the first user for selecting among the default view and the first user-defined view, and may also display a second user-accessible selection utility configured for the second user for selecting among the default view and the first user-defined view. In response to detecting that the first user is currently requesting access to the data item, the host system may be configured to display the first user-accessible selection utility and that users preferred view of the data. Similarly, in response to detecting that the second user is currently requesting access to the data item, the host may be configured to display the second user-accessible selection utility and the second user's view/s and or preferred view of the data.

The user-configurable elements of view may include any combination of a label displayed adjacent to a display of the data item, a prompt displayed outside or inside a field in which the data item is displayed, the prompt being replaced by the data item after an initial period of display, or when data is entered, one or more messages displayed or played in association with the data item, one or more pop-up help items selectively displayed or played in association with the date item, one or more shapes associated with the display of the data item, one or more border shapes associated with the display of the data item, one or more backgrounds associated with the display of the data item, and one or more sounds, images, animations or one or more activities comprising executable steps. Further user configurable elements of a view may include ability to group or ungroup items with other items into the existing or a new view, to add or remove animations, to add or remove fields, to add or remove images as backgrounds to any element in the view including to the view itself, to add or remove user messages, to add or remove any available functionality such as email or lookup functionality and to create, add or remove a new type of record that is then part of that view, to propagate changes made to one view to other elements in that view or in other views, to turn help on or off, and to control other functionality in the view as well as to change such factors as the color, or where appropriate, the thickness of something, for example, of a border.

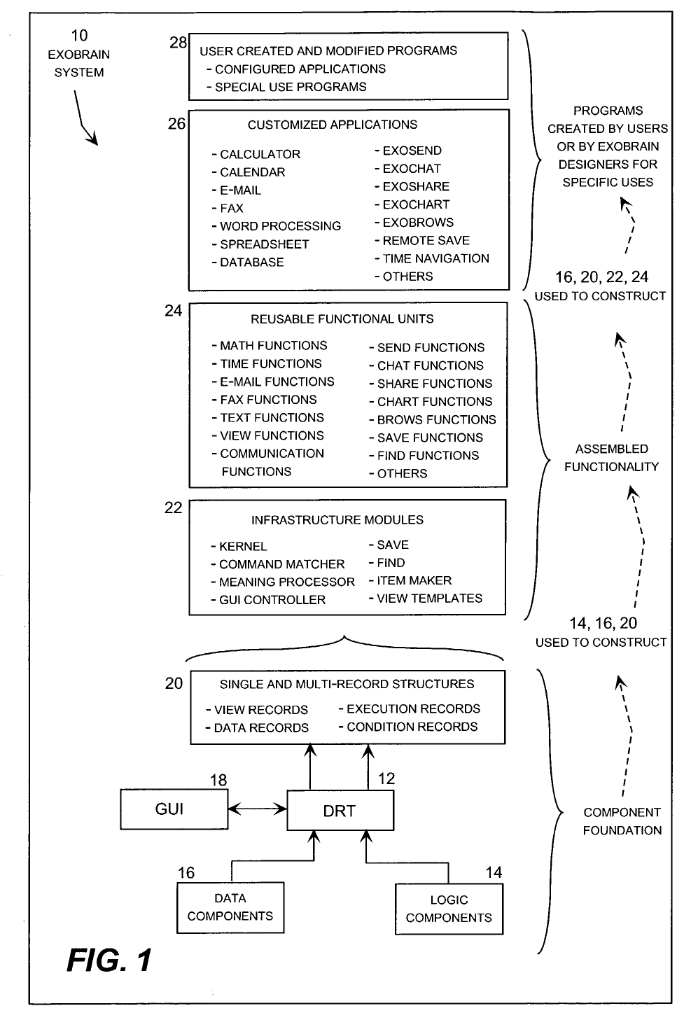

FIG. 1 is a functional block diagram of an EXOBRAIN system 10, in which the dynamic item manipulator may be implemented. The fundamental elements of the EXOBRAIN are a data relation table (DRT) 12, a set of logic components 14, a set of data components 16, and a graphical user interface 18. The DRT 12 includes a database of records and accompanying functionality specifications in which the structure and methods of the EXOBRAIN system may be implemented. In particular, data and logic may be incorporated into individual DRT records through functionality specifications that may be implemented through administration fields and a data class structure that cooperate with each other to implement a universal interface for recording, accessing, and manipulating any type of data, and implementing any type of software, within the EXOBRAIN system 10. Thus, all applications create in the EXOBRAIN system 10 share a common infrastructure and interface, and may therefore communicate with each other without interface-imposed or data structure-imposed boundaries.

To implement software, the records in the DRT 12 may incorporate compiled software components either directly or by reference to the stored logic components 14, which are a set of compiled software components that can be assembled into higher-level functional units within the DRT structure. Nevertheless, the DRT 12 may also store or reference un-compiled code, which can be compiled “on the fly” using functionality implemented within the DRT structure. In a similar manner, the DRT 12 may incorporate data components either directly or by reference to the stored data components 16, which may be assembled into higher-level data units within the DRT. Although they are shown as external to the DRT 12 in FIG. 1, all types of data, including the logic components 14 and the data components 16, as well as infrastructure modules 22, reusable functional units 24, customized applications 26, user created and modified programs 28 and GUI code 18 may be stored within the DRT and an EXOBRAIN functions best and is most flexible if so stored. For descriptive convenience, however, these items and the logic components and the data components may be referred to or illustrated as items that are separate from the DRT, which is a viable (but merely illustrative) embodiment of the EXOBRAIN system 10.

The graphical user interface (GUI) 18 and the GUI controller 22 collectively provide a mechanism for converting human-communicated data and instructions into DRT format, and for converting DRT-housed data and instructions into human perceptible forms. For example, the GUI controller 22 may drive a conventional computer screen and associated peripheral devices. As noted above, the data class and administration field structure of the DRT 12 create a universal data classification system that allows data and software components to be stored in fields of DRT records. In particular, a component may be included in a field of a DRT record by including the substantive data or software element itself in the DRT record, or by including a pointer in the DRT record. This pointer, in turn, may identify the substantive data or software element, or it may identify another pointer that ultimately leads to the substantive data or software element. In other words, a substantive data or software element that is located outside a DRT record may be incorporated into the DRT record by reference. It should be appreciated that, in the any-to-any system, software components are simply treated as another, specialist form of data. As such, software may be incorporated into a DRT record just like any other type of data. The only difference is that a DRT record containing a software component allows the substantive code to execute when the DRT record is processed, whereas a DRT record containing a data component presents the substantive data elements for manipulation when the DRT record is processed.

Whether data or software, the presence of a particular component in a particular field of a DRT record may be used to relate that component to other components located in the same field in other DRT records. This principle of relating data items to each other based on field location or storage pattern similarity is referred to as a “field parallel” record structure. In other words, a field parallel record structure involves locating components in the same field of different DRT records to connote a relationship between the components. The relationship implied by the field parallel record structure may, in turn, be considered when implementing operations utilizing both components while, at the same time, keeping each component entirely separate from the other in individual records. In addition, the individual records containing components that “go together” may be referenced in a third record, such as a list record. For example, a particular software record may go with a particular set of data records, or a mixture of software and data records. Notwithstanding this operational relationship among the records, none of the records or the data they contain necessarily become part of a programmer-coded construction entity, as would occur in conventional software. This is because the relationships between the components is expressed in the DRT 12 rather than in the compiled code, and the DRT is a database that may be freely manipulated by the user without having to alter the underlying compiled code.

As a result, higher-level software applications may be implemented within the DRT 12 by referring to the compiled code residing in the logic component table 14 and the individual data components residing in the data component table 16 without having to alter the underlying logic and data components, and without having to compile the higher-level software. In other words, the DRT 12 implements a vehicle for assembling the underlying logic components 14 and data components 16 into single and multi-record structures 20 for incorporating all types of data and implementing all types of software functions within the DRT 12. Specifically, the single and multi-record structures 20 generally include data records for incorporating data items into the DRT 12, execution records for incorporating software items into the DRT 12, condition records for specifying conditions for executing a corresponding execution record, and view records of different types for specifying elements to displayed in connection with a corresponding data item as well as other types and sub-types of records.

These single and multi-record structures 20, as well as individual logic components 14 and individual data components 16, may be used to create infrastructure modules 22. These infrastructure modules 22 implement reusable functionality that in most cases is not normally directly accessed by the user. The infrastructure modules 22 typically include a kernel for integrating the EXOBRAIN system with the operating system and other external hardware and software elements. The infrastructure modules 22 may also include a command matcher module that enables command output from either a meaning processor or the GUI 18, or both, to be matched to specific execution records. The infrastructure modules 22 may also include a GUI controller to connect the records of the DRT 12 with the GUI 18. The infrastructure modules 22 may also include a meaning processor for resolving language data into numbers concept language, using numbers concept language records stored in the DRT 12. This enables the EXOBRAIN system to receive commands in natural human language, translate them into correctly formatted DRT records containing the correct numbers concept language values, and output records that are ready to be matched by the command matcher to specific execution records or to records that kick off suitable executions records or logics when they are selected by the matching process.

Referring now to the interrelated operation of the infrastructures modules 22, when the EXOBRAIN system 10 first starts, the bootstrap logic, which instantiates and initializes the EXOBRAIN system, supplies the GUI controller with an initial view, which is used as a desktop but is otherwise a view like any other. In this particular embodiment, the GUI controller is not necessarily a single or multi record structure, but may be compiled code that accepts DRT records as input and outputs commands that drive the GUI 18, which is described in U.S. patent application Ser. No. 09/710,826 entitled “Graphical User Interface.” The GUI 18, in turn, interfaces with the keyboard, mouse, speakers and other input-output devices via the Java run-time structure that effectively interfaces between the Java class files and the underlying operating system. Equally, if Java is not being used, the equivalent functionality can be constructed in any other suitable programming language.

The desktop view typically contains buttons that enable the user to implement a sufficient menu of functionality to get the system started. Optionally or alternatively, the desktop may include a talk box into which commands can be entered for subsequent processing by the meaning processor. Although a visual input-output mechanism is used as an example in this specification, the same general principles are applicable to, and provide a foundation for, a non-visual input output system, such as text to speech combined with voice recognition (speech to text), although additional and obvious parts may be required to implement these capabilities.

The mechanisms for implementing a button are described below to illustrate the principles that are generally applicable to all active elements in the EXOBRAIN system 10. Briefly, “active elements” may be used to implement all of the elements displayed by a user interface, such as a button, a box, a sound, an executable instruction, etc. Any particular button is usually represented as an independent record of its own (button) type, which contains in its different fields all the appropriate parameters to specify the display and activities of that button. This record may be a list record that identifies other records, or it may specify the button's parameters in a vector referenced in the method field or in an alternative suitable field that is a standard part of every DRT record. Alternatively, otherwise unused fields on other records may be used to store the appropriate parameters to define a button in a standard manner for all buttons. In any case, the administration fields in the DRT 12 are used to designate particular record types, including the button record type and all other record types. In addition, administration fields designated as “Name” or “Given Name of This Item” and associated sub-type fields may be used in a standard manner to permit all button records to be located with a “find specification,” which sets forth a set of record characteristics that define a search request for records within the DRT 12 that correspond to the find specification. The general method for construction, saving and using a find specification is described in the U.S. patent application Ser. No. 09/712,581 entitled “Any-To-Any Component Computing System.”

Specifically, buttons records having certain parameters may be located by specifying their respective records using the “menu” field of the DRT 12, which can either contain a vector or (preferably) point to a list record containing the record list. Alternatively, button records having certain parameters may be located by running a find specification to locate buttons conforming to the specified parameters. Clicking a button causes the GUI controller to communicate this in the form of DRT records to underlying modules that fetch the button's DRT record and pass this record to the command matcher module, which then uses that record as a find specification to locate the appropriate execution record or records in the DRT 12 for that button. More specifically, the command matcher module uses the button's DRT record received indirectly from the GUI controller as a find specification, which the command matcher uses to locate the appropriate execution records in the DRT 12 for that button. The command matcher then supplies the button's execution records to the kernel, which causes the compiled code contained in or referenced by the found execution records to execute.

Active elements operate in a similar manner, which means that the GUI controller accepts user interface commands as inputs, and outputs DRT records, which may be immediately passed to the command matcher module or stored and made available for reload later. This process may also work in the other direction, in which the GUI controller receives DRT records and inputs, and outputs commands that drive the GUI 18. The properties of an active element include, but are not limited to, background shape, size, location, image and color; border type and width; system text font, size, text colors and styles; user entered text font, size, colors and styles; mouse actions for clicks, drag and other effects; etc. Because properties are constructed in a modular manner, new properties can be added on the fly without reconstruction and when added, become immediately available to all active elements.

In the collection of code referred to as the GUI controller, each property has two logics. One logic may be used to return the value of the property, and another logic may be used to change the value of the property. Collectively, these logics constitute the run-time interface that allows the code underlying the data-handling execution records to have full control over every aspect of any active element on the screen. Hence, the GUI and GUI controller do not themselves take any independent action, but simply respond to the orders received from any underlying modules in the form of DRT records on the one hand, and, on the other, outputs whatever the user does in the form of DRT records, which are then used by the code of underlying execution records. Hence, the screen is able to respond to the orders of any underlying modules, so long as they communicate in the standard manner using DRT records. Feeding suitably changing parameters to the GUI controller 20 run-time interface results in animation; as examples of this, feeding a continuously changing series of coordinates results in an active element moving across the screen; feeding different size coordinates in a loop makes the active element appear to pulse, and so forth.

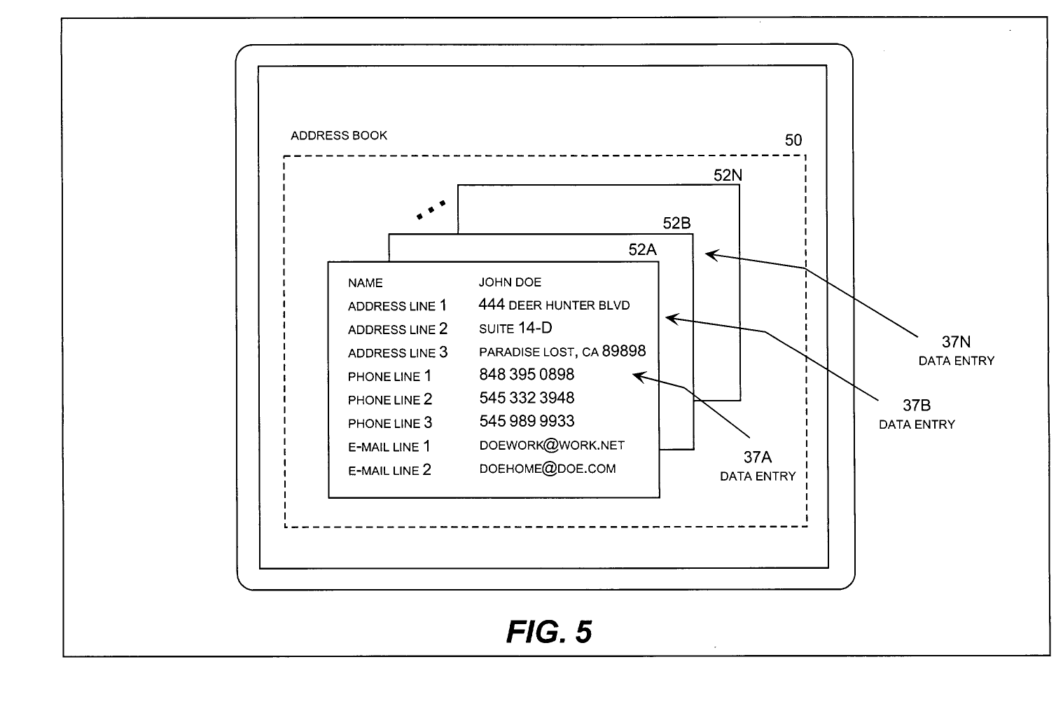

Hence, the active element editor 60 (shown on FIG. 5) is simply a view that calls certain logics to change property values through the run-time interface. Generally, the active element editor 60 has an active element for each property or group of properties. The appearance or construction of an active element editor as it appears on the screen is irrelevant to the underlying functionality because the view of the active element editor is just another view that can be customized like any other and in an ExoBrain, everything that appears on the screen is either a view, or a part of a view. Active elements can communicate with one another, also using the run-time interface. For example, an active element can be created to work directly on another active element, or it can be configured to find another active element at run-time by name. This particular mechanism is typically used in the case of the active element editor, in which buttons are used to call other appropriate other active elements to be displayed, which constitute what appears as a menu launched by that button. These infrastructure modules allow the user, through the GUI 18 and the DRT 12 to control the EXOBRAIN system 10, to access and control all types of data and execute all types of code contained in or referenced by the DRT 12.

The infrastructure modules 22 also include a number of reusable lower-level modules 20 or logics 14 that the higher-level applications may incorporate by reference or call on demand to include the associated functionality in the higher-level applications without having to create multiple instances of the lower-level reusable functional units. For example, these functions may include save elements, find elements, item maker elements, the modules and logics needed to create and use view templates, and other lower-level reusable components as determined by the EXOBRAIN system developers. These infrastructure modules 22, in turn, are available to be called by or referenced by higher-level reusable functional units 24, such as math functions, time functions, e-mail functions, fax functions, text functions, view functions, communication functions, send functions, chat functions, share functions, chart functions, share functions, browse functions, save functions, find functions, and other higher-level reusable components as determined by the EXOBRAIN system developers. The logic components 14, the structure and function for recording and using data components 16, and the infrastructure modules 22 are typically created and used by EXOBRAIN system developers to create the user-accessible reusable functional units 24. These user-accessible reusable functional units 24, along with the individual data components 16, the single and multi record structures 20, and some of the infrastructure modules 22 may be accessed by non-programmer designers and end users to create the EXOBRAIN equivalent of commercial grade applications 26 of all descriptions. Typically, the logic components 14 are not made directly available for end users or program designers to access in the construction and manipulation of the higher-level applications 26. That is, professional program designers and end users are typically permitted access to the reusable functional units 24, the data components 16, the single and multi record structures 20, and some of the infrastructure modules 22, which they use to construct customized applications 26 of their own design.

Further, the higher-level reusable functional units 24 are typically designed so that they may be made generally available to users of all descriptions. Nevertheless, for commercial reasons depending on the target customers of a particular EXOBRAIN system or product, access to the reusable functional units 24 may be limited to professional designers who create the EXOBRAIN system equivalent of higher-level commercial grade applications 26, which in turn may be directly accessed by end users. These commercial grade applications 26 typically include at least a calculator application, a calendar application, an e-mail application, a fax application, a word processing application, a spreadsheet application, a database application, an application for sending data between host systems, an application for implementing chat between host systems, an application for sharing data among host systems, a charting application, a browser application, a remote save application, navigation applications, and other higher-level customized applications as determined by the EXOBRAIN system developers. However, the tool set made available to designers and end users alike is designed to allow all users to customize pre-configured application and create new applications from scratch. That is, end users and EXOBRAIN application designers may further customize and adapt the customized applications 26 to create highly configured applications and special use programs 28 for a virtually unlimited range of applications, or alternatively, may create such highly adapted applications from scratch using the reusable functional units 24, the data components, or component data structures and functions, or both, 16, the single and multi record structures 20, and the infrastructure modules 22. In addition, the end user-functionality 26, 28 of each user's EXOBRAIN system may be both created and modified by and for that particular user or use “on the fly” without having to recompile the underlying code.

Because the compiled software components are incorporated by reference into the DRT 12, and may optionally also be stored in it, the individual compiled components can be incorporated into many different software assemblies without having to maintain multiple instances of the compiled components and without having to write multiple instances of code that is similar in function, and essentially similar in construction but adapted for a different application. This reduces the size of the compiled code for sophisticated software by factors of hundreds or thousands and also reduces the number of sources, and hence the complexity and effort required to detect and correct “bugs” due to the absence of multiple very similar (but not identical) blocks of code performing essentially the same function but in different “applications.” In addition, new software may be written, and existing software may be altered “on the fly,” without having to interrupt the user sessions to recompile the underlying code. Further, pre-configured labels and other text items may be changed “on the fly” without having to interrupt the user sessions to recompile the underlying code and a further result is that any user can easily create and store multiple views for data items “on the fly” during an uninterrupted user session.

The practice of recording all of the parameters specifying a view as records stored in the DRT database 12 enables the views to be transmitted to other EXOBRAIN systems in a very compact form that transmits quickly, and in such a manner that they can be processed appropriately by the recipient EXOBRAIN system on arrival. This allows each user to exchange views with other users using e-mail, file sharing, electronic chat and other available mechanisms for exchanging electronic data. Because the views are implemented within the EXOBRAIN infrastructure, complex views including images, animations, sound, and executable activities may be transmitted from one EXOBRAIN system to another, and the views run properly when received during an uninterrupted user session. In some instances, a view may utilize a logic component that is not included in the receiving party's set of compiled logic components 14, or a data component that is not included in the receiving party's set of data components 16. In this case, the receiving EXOBRAIN system can be set up to recognize this condition and to request a download of the missing component from the transmitting EXOBRAIN system or from elsewhere. This process, which can occur automatically during the on-going user session, seamlessly updates the receiving party's EXOBRAIN system. As a result, the received view can function properly when received or moments later.

The EXOBRAIN system described above represents a fundamentally new paradigm for software construction that solves the systemic problems encountered with conventional methods for assembling software. Many highly useful and previously unattainable software features and features only attainable with much greater difficulty of construction and use and cost and time can be implemented in this type of programming environment with greatly reduced construction time and difficulty, greatly reduced storage requirements, and greatly simplified maintenance and upgrading regimes as well as with greater simplicity for the user and greater transparency of the underlying mechanics for the user as well as overall power, as users can now construct their own applications without programmer assistance. In particular, the dynamic item manipulator described below is one example of such a feature that becomes easier to enable in this environment. The dynamic item manipulator allows multiple users to each create and save multiple views for data items to be rendered by the EXOBRAIN system. These user-defined views can be created, saved and subsequently accessed “on the fly” during an uninterrupted user session without having to recompile any code or restart an application or file. As a result, every user can easily create customized views for himself or others to implement a wide range of functions, such as screen text in different languages, creation of training platforms, displaying helpful items in a user's own words, customized data views for special purposes, customized data views for other persons, and so forth.

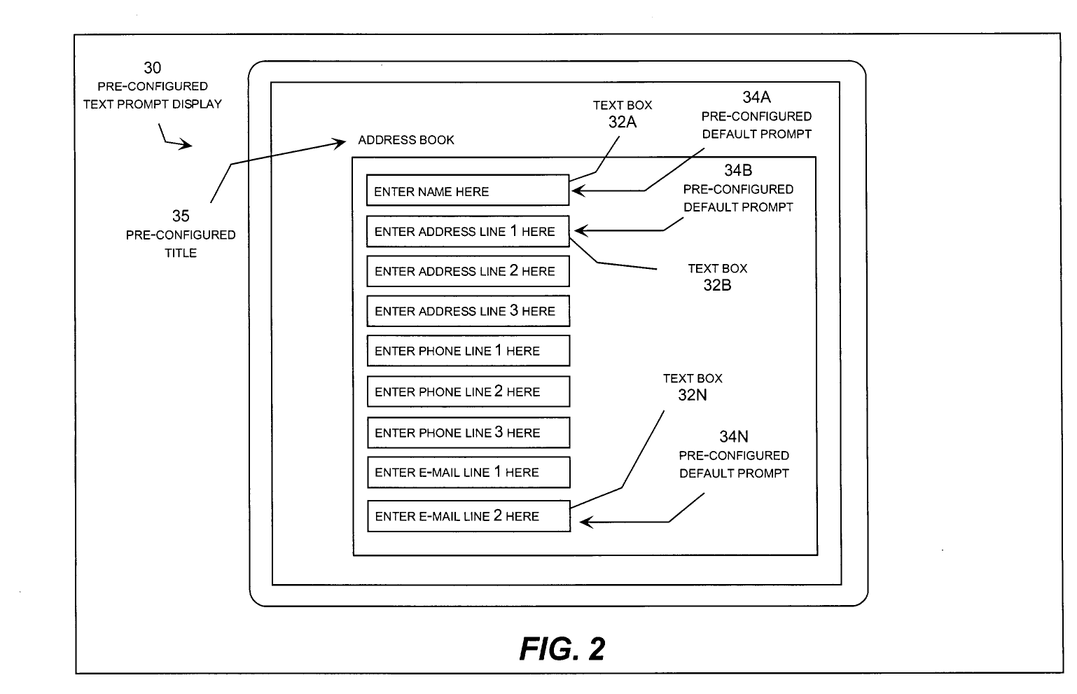

FIG. 2 is a pre-configured text prompt user interface display 30 illustrating text boxes 32A-N containing pre-configured type-over prompts 34A-N displayed within the text boxes. The display 30 also includes a pre-configured title 35, in this example “Address Book.” For this example, the text boxes 32A-N are configured to receive data entries defining address entries for the address book, and the type-over prompts 34A-N instruct the user to enter the items of the data entries into the text boxes. For example, the text box 32A displays the pre-configured type-over prompt 34A stating “enter name here“; the text box 32B displays the pre-configured type-over prompt 34B stating “enter address line 1 here” and so forth. It should be appreciated that this address box example is described to illustrate the principles of the invention, which can be applied to any type of user interface utilizing text boxes for receiving data from a user.

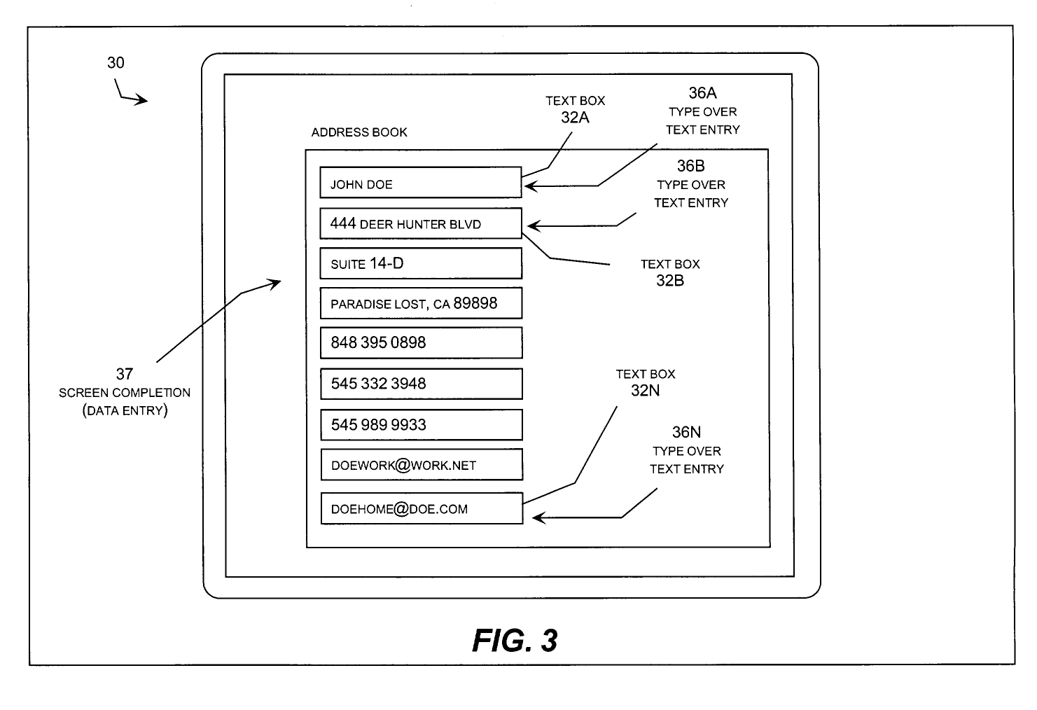

FIG. 3 shows the user interface display 30 after the user has entered a multi-box data entry 37A into the text boxes by typing the data entries over the pre-configured type-over prompts. Of course, the data entries may be “typed” into the box using a keyboard, voice recognition device, touch screen, or any other suitable data entry device that produces text for the text boxes. For example, the user entered “John Doe” into the text box 32A, which replaced the pre-configured type-over prompt 34A stating “enter name here“; the user entered “444 Deer Hunter Blvd” into text box 32B, which replaced the pre-configured type-over prompt 34B stating “enter address line 1 here” and so forth. The use of type-over prompts displayed within the text boxes, as shown in FIGS. 2 and 3, saves screen space by avoiding the need for prompts, or labels or both placed adjacent to the text boxes. This results in an important advantage for busy data screens, and is an especially important advantage for very small screens such as those included on personal digital assistants, wireless telephones and the like.

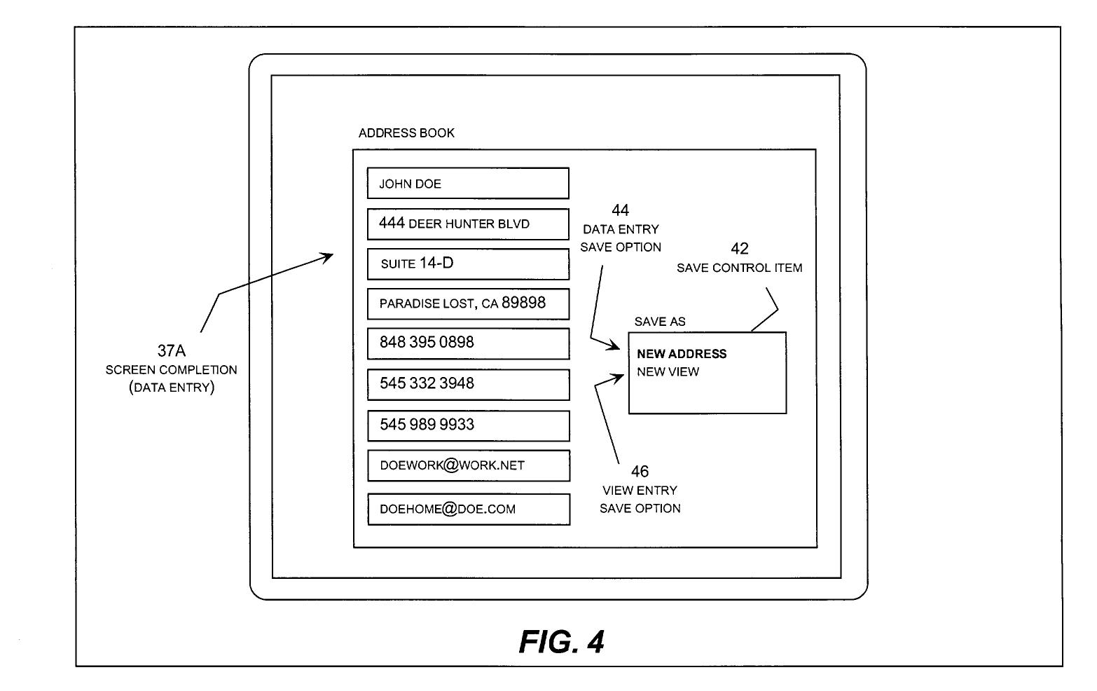

FIG. 4 is a user interface display illustrating a save control item 42 for saving the data entry 37A received through the text boxes 32A-N in a database. In particular, the save control item 42 offers the user two save options including a data entry save option 44 and a view entry save option 46. When the user has entered a data entry 37A defining an address to be saved, as shown in FIG. 4, the data entry save option 44 is the appropriate selection. Selecting this option, which is shown highlighted in bold in FIG. 4, saves the data entry 37A in a database, in this example, as an entry in the address book. FIG. 5 is a block diagram illustrating the database, in this example address book 50, created by saving data entries as shown in FIG. 4. For example, the data entry 37A shown in FIG. 4 produces an address record 52A stored in the address book 50 while additional data entries 37B-N created with the text box display 30 produce similar address record 52B-N. In these entries, the pre-configured text prompts 34A-N correspond to labels identifying associated items of the data entries in the address records 52B-N. For example, the pre-configured text prompt 34A stating “enter name here” is the prompt for the same field as the field showing the label “name” associated with the data entry item “John Doe” in the address record 52A, which the user entered into the text box 32A. Similarly, the pre-configured text prompt 34B stating “enter address line 1 here” corresponds to the label “address line 1” associated with the data entry item “John Doe” in address record 52A, which the user entered into the text box 32B, and so forth. In other words, the pre-configured text prompts 34A-N as well as the user's data entry items are reflected in the database record, in this example the address record 52A, where the database record shows the user-entered data as well as labels that have not been displayed in views 52A-N.

Specifically, the data entry 37A may be stored in a DRT data structure, such as that described with reference to FIG. 1, which typically stores a complete definition of the user interface display 30. Specifically, the view of the user interface display 30 may be expressed in DRT format by a top-level list record that incorporates a list of other records that further define the view. The name of the view, “Address Book” in this example, typically appears in the “name” field within the administration category of the top-level list record. Placing the entry “Address Book” in the “name” field allows a find specification to be created to locate this record by searching for items with the name “Address Book.” A find specification is an EXOBRAIN infrastructure-level function that typically operates in association with administrative fields, such as the “name” administration field, as described in more detail with reference to FIG. 1.

The top-level list record for the view 30 may also include a list of additional records that further define the view, typically within consecutive fields within the data section of the DRT record. These records are usually organized in a field parallel structure, which is also described in more detail with reference to FIG. 1. It should be noted that every attribute of the view 30 does not need to be directly included in the top-level list record because each record in the top-level list may, in turn, identify a sub-assembly including a list record further defining the referenced record. The sub-assembly list record may, in turn, identify its own sub-assembly record, which may includes another list record. This process may be repeated as many times as necessary to create a nested set of DRT records defining every aspect of the view 30, including every visible element and every other effect associated with the view.

The tying element for the example involving view note 30 described above is a nested record path emanating from the top-level template list record. However, other types of tying elements may be implemented. In addition, the substantive data item, in this example a text string, may be directly included in an associated DRT record. Alternatively, the substantive data item may be composed of reusable data components that are incorporated into the DRT structure by reference to another location containing the substantive data item or a pointer that ultimately leads to the substantive data item. In particular, the DRT record structure may ultimately incorporate the substantive data items through reference to the reusable data components 16 shown on FIG. 1. Software may be similarly incorporated by reference to the reusable logic components 14, which are also shown on FIG. 1.

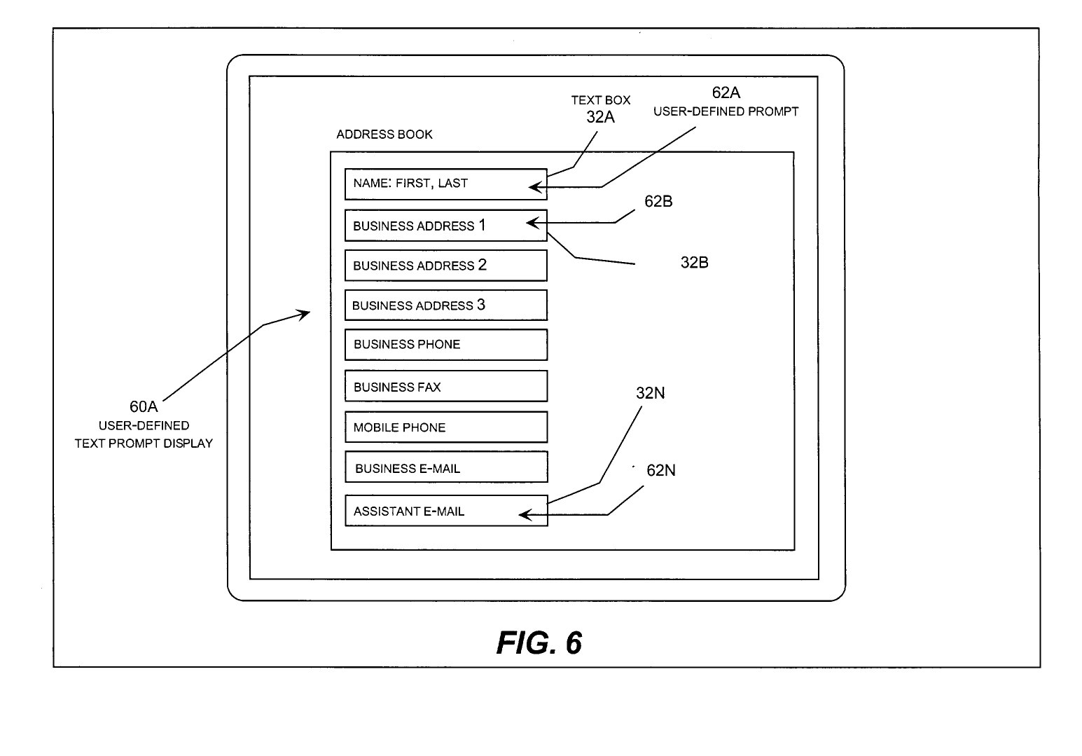

FIG. 6 is a user interface display 60 illustrating the default user interface display 30 altered by the user to include user-defined type-over prompts displayed within the text boxes. That is, the text box software allows the user to enter into a text box configuration mode in which the user may redefine the type-over prompts displayed within the text boxes, as has been done in FIG. 6. The user may activate the text box configuration mode in any suitable manner, such as selecting a menu command, entering a predefined key stroke or sequence, placing the cursor in a predefined location and right-clicking the mouse, etc. Once text box configuration mode has been activated, user entries in the text box no longer result in entry of data, but instead, and either in the text box itself, or in a separate display (depending on which is most convenient or preferable for the usage concerned) the user simply enters the desired user-defined prompts 62A-N over the pre-configured text prompts 34A-N within the text boxes 32A-N to produce the user-defined text prompt display 60. For example, the user entered the user-defined prompt 62A stating “name: first, last” to replace the pre-configured prompt 34A stating “enter name here” in text box 32A. Similarly, the user entered the user-defined prompt 62B stating “business address 1” to replace the pre-configured prompt 34B stating “enter address line 1 here” in text box 32B, and so forth. It will be appreciated that the ability to replace a particular prompt with another, equally enables a type over prompt in one language to be translated into a type over prompt in another language, and that this enables prompts in a particular view or screen to be translated into another or other languages at negligible cost and effort and without needing to change such texts in the interior of the compiled code. This advantage is important in multi-national environments such as that of the European Union.

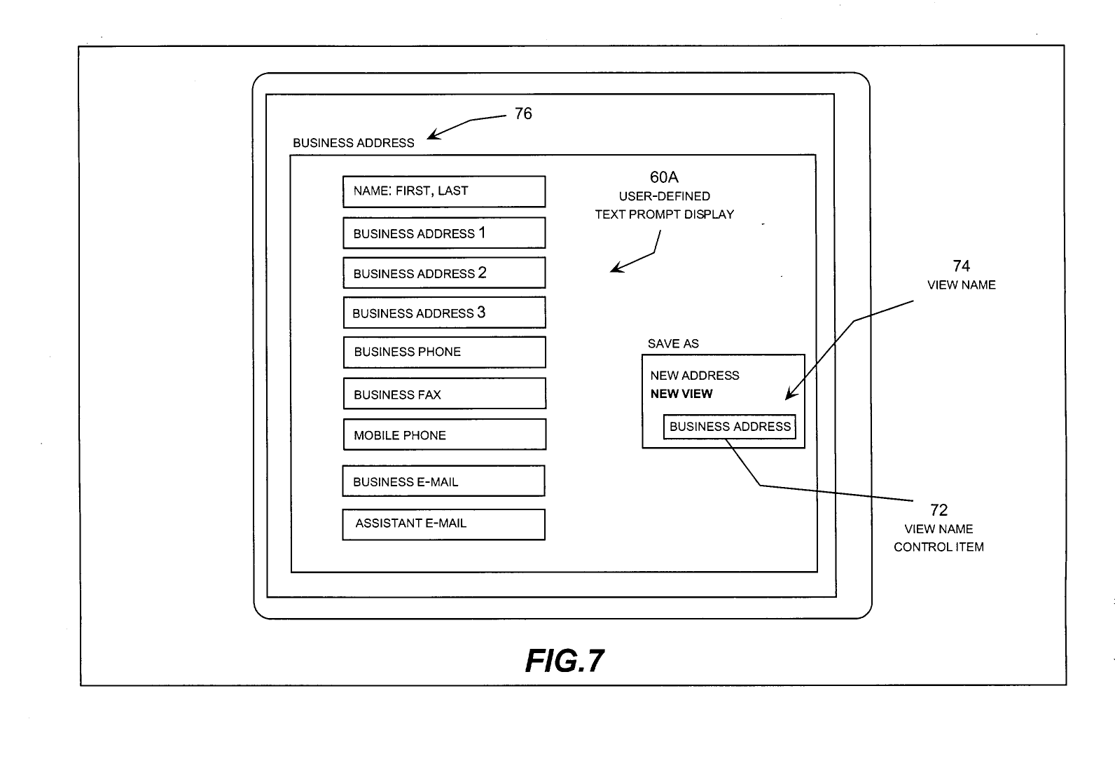

FIG. 7 again shows the save control item 42 of FIG. 4, which at this point in the example is used to save the user-defined text prompt display 60. In particular, when the user has entered a user-defined text prompt display 60 defining a new view for the user interface, as shown in FIG. 7, the new view save option 46 is the appropriate selection. Selecting this option, which is shown highlighted in bold in FIG. 7, saves the user-defined text prompt display 60 as a new view for the user interface that the user may later activate to receive, display, or otherwise manipulate data entries. To identify this particular view, a view name control item 72, in this example a text box, is displayed. The user enters the desired view name 74 into the text box and activates a save command to save the new view under the desired view name 74, in this example “business address.” The user-defined view name 74 can be made then, if desired, to replace the pre-configured title 35 in with a title of the same wording as the view as shown in 76 of the user-defined text prompt display 60, as shown in FIG. 7.

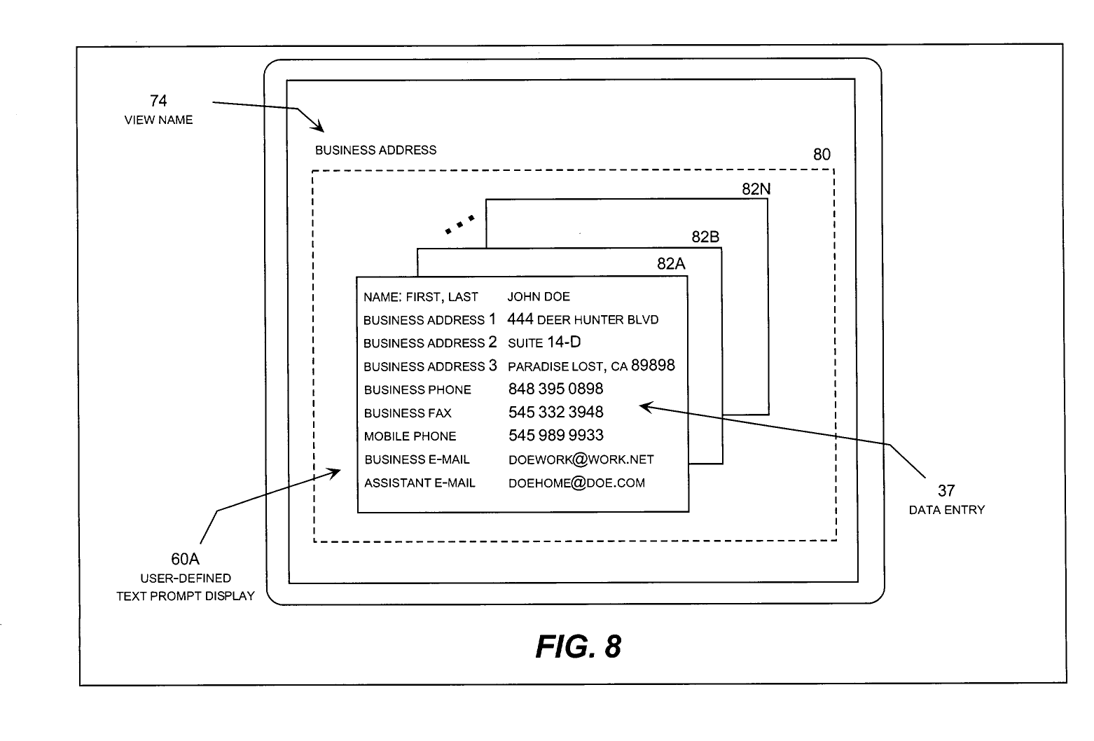

In addition, the user-defined text prompt display view 60 can also be used to indicate that a category of the address entries in the address book called “business names” has been defined in the address book, as a sub-category of the general category of addresses, using the appropriate fields in the Data Relation table to do so. FIG. 8 is a block diagram illustrating an address category 80 that was created as described above and accompanied by saving a view with the same name and then saving associated data entries in the manner described above with reference to FIG. 7. For example, entering the data entry 37A of FIG. 3 and FIG. 4 into the user-defined text prompt display 60 shown in FIG. 7 produces an address record 82A in a “business address” category 80 in the user's address book. In this example, the view name 74 “business address” indicates that the defined category name of “business addresses” is in use in the address book because it has been arranged that changing the view to the “business addresses” view also results in the selection and saving records being made to this category. In these entries, the user-defined text prompts 62A-N correspond to labels identifying associated items of the data entries in the address records 82B-N. For example, the user-defined text prompt 62A stating “name: first, last” corresponds to the label “name: first, last” associated with the data entry item “John Doe” in the address record 82A, which the user entered into the text box 32A. Similarly, the text prompt 62B stating “business address 1” corresponds to the label “business address 1” associated with the data entry item “444 Deer Hunter Blvd” in address record 82A, which the user entered into the text box 32B, and so forth. In other words, the user-defined text prompts 62A-N as well as the user's data entry items are reflected in the database record, in this example the address record 82A. However, when labels are also redefined by the user in this manner, so that the label for a field such as text box 32A of FIG. 2 has a default value of “name” as shown in 37A of FIG. 5, is redefined by the user to be “name: first, last” as shown in 82A of FIG. 8, this is optimally done in a separate and different field in the database to the field containing the default label “name”. When so enabled, the host computer, detecting that a particular user or a particular category of records is in use, can be made to access the appropriate records by using the appropriate field for the lookup. For example, if the user has queried for a particular address, for example “444 Deer Hunter Blvd” as shown in text box 32B of FIG. 3, the computer can look this up based on the default label in use, namely “name” and thereby find the appropriate record, whether or not the address happens to be a member of the business category or not. However, if the user queries for the first line of a business address then the label “business address line 1” which resides in a different field, can be used as part of the basis of the lookup.

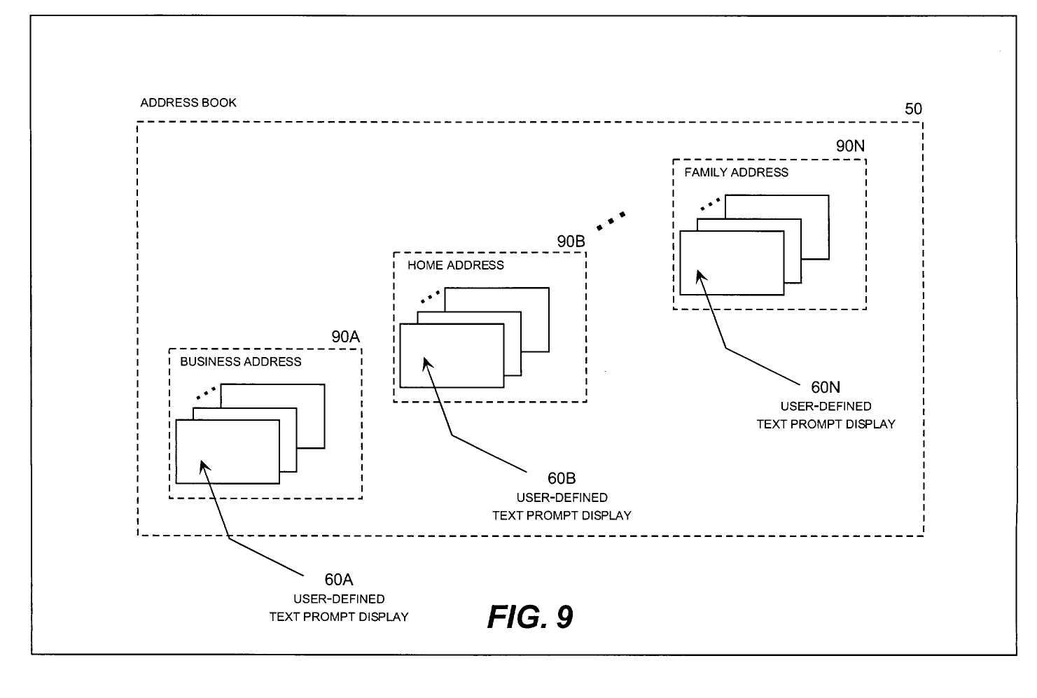

FIG. 9 is a block diagram illustrating the database, in this example the address book 50, containing a number of address categories 90A-N created in the manner described above with reference to FIG. 8. Specifically, the user created a first user-defined type-over text prompt display 60A, saved this view under the view name “business address,” and used the view as part of creating the “business address” category 90A of address records. Similarly, the user created a second user-defined type-over text prompt display 60B, saved this view under the view name “home address,” and used the view as part of creating the “home address” category 90B of address records, and so forth.

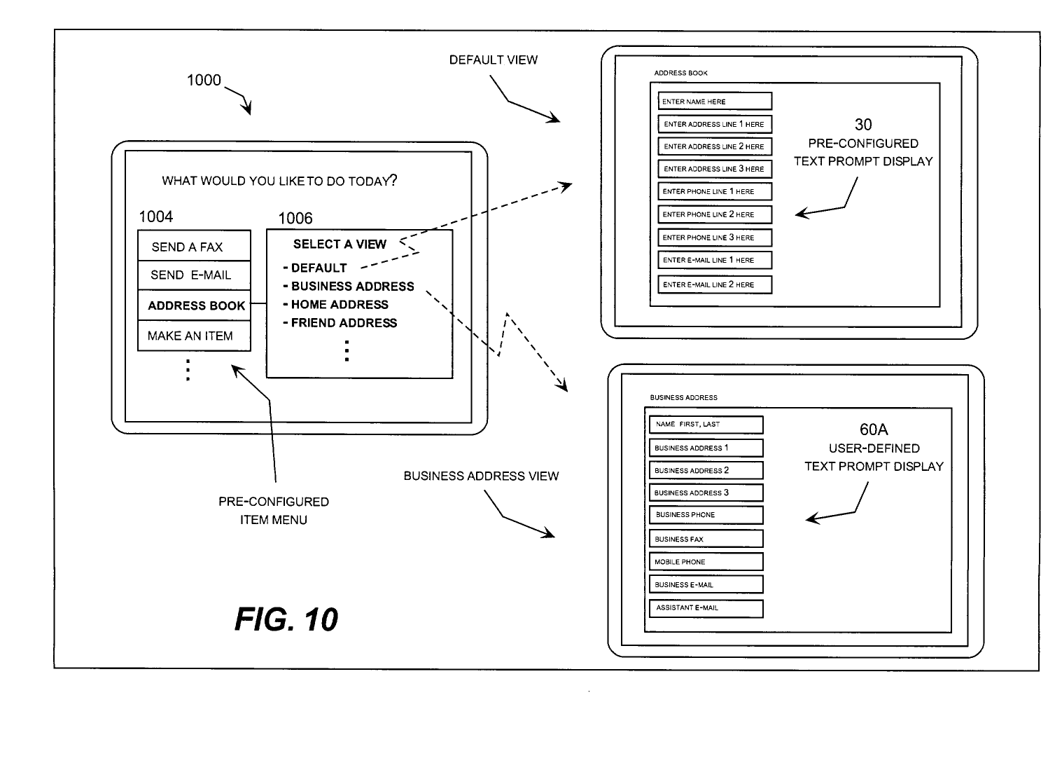

FIG. 10 is a user interface display illustrating a view selection utility 1006 that allows the user the select among a group of views containing user-defined type-over text prompt displays, such as the displays 60A-N, to create new address records and store them in their associated categories 90A-N in the database, in this example address book 50. In particular, the user interface 1000 includes a pre-configured item menu 1004 including an “address book” item. Selecting this item causes the view selection menu 1006 to pop up. This menu displays the “address book” views available for selection, including the “default” item corresponding to the pre-configured text prompt display 30, a “business address” item corresponding to the user-defined “business address” text prompt display 60, which is used to create the “business address” category of address records 90A. The view selection menu 1006 also includes a “home address” item corresponding to a second user-defined “home address” text prompt display, which was created as part of creating the “home address” category of address records 90B, and so forth. Selecting the “default” item activates the pre-configured text prompt display 30, selecting the “business address” item activates the user-defined “business address” text prompt display 60, and so forth, since it is supposed that in this arrangement, the user has also arranged that selecting the view containing the user-defined prompts also acts to selects the appropriate category of records at the same time. While this shows one method of selecting a view containing default or user-defined prompts, alternatives exist using the same methods, which may be more suitable under different circumstances. For example, matters may be so arranged that when a particular user selects the address book 1004 the view that is shown is the last view he was using, or the last category, or both, and a “switch views” button may be provided that produces a list of available views such as those shown in 1006 together with, or separate from, a similar view enabling him to change categories at the same time, or separately.

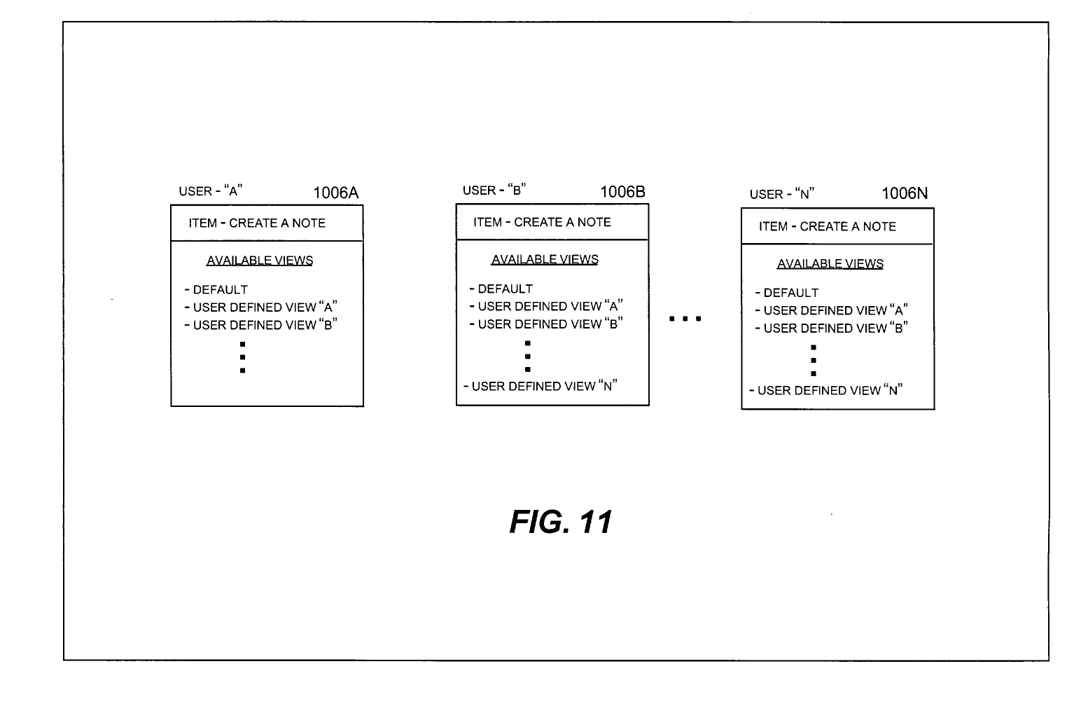

FIG. 11 is a block diagram illustrating multiple view selection utilities 1006A-N, which allow different users to select among views of a text box user interface that they created containing different user-defined type-over prompts. That is, each user may create, save and access his or her own set of user-defined type-over prompt displays. In addition, each user may create an analogous set of user-defined type-over prompt displays for a wide variety of different applications using text boxes. Users may add more complicated elements to views, such as sounds, animations, images and executable activities. Moreover, users may e-mail views to each other, share them in chat sessions, and otherwise exchange views. Because the views are implemented within the EXOBRAIN infrastructure, complex views including images, animations, sound, and executable activities may be transmitted from one EXPBRAIN system to another, and the views run properly when received during an uninterrupted user session. In some instances, a view may utilize a logic component that is not included in the receiving party's set of compiled logic components 14, or a data component that is not included in the receiving party's set of data components 16. In this case, the receiving EXOBRAIN system recognizes this condition and requests a download of the missing component from the transmitting EXOBRAIN system. This process, which occurs automatically during the on-going user session, seamlessly updates the receiving party's EXOBRAIN system. As a result, the received view functions properly when received.

In view of the foregoing, it will be appreciated that present invention provides a more effective and flexible method for using text boxes to receive data from a computer user. It should be understood that the foregoing relates only to the exemplary embodiments of the present invention, and that numerous changes may be made therein without departing from the spirit and scope of the invention as defined by the following claims.

The invention claimed is:

1. A method for receiving, displaying or using data through a user interface, comprising the steps of:
displaying a text box with a pre-configured prompt displayed within the text box;
receiving user input defining a data entry;
replacing the prompt with the data entry within the text box; and
saving the data entry as a text box response in a database.

2. The method of claim 1, further comprising the step of performing the method of claim 1 during an uninterrupted user session.

3. A computer storage medium comprising computer-executable instructions for performing the method of claim 1.

4. An apparatus configured to perform the method of claim 1.

5. A method for receiving data through a user interface, comprising the steps of:
displaying a text box with a pre-configured prompt displayed within the text box;
receiving user input defining a user-defined prompt;
replacing the pre-configured prompt with the user-defined prompt within the text box;
receiving user input defining a data entry;
replacing the user-defined prompt with the data entry within the text box; and
saving the data entry as a text box response in a database.

6. The method of claim 5, further comprising the steps of:
receiving user input defining a user-defined view name associated with the user-defined prompt;
storing the user-defined prompt in association with the user-defined view name in the database;
displaying a view selection utility comprising the user-defined view name and a default view name associated with the pre-configured prompt;
receiving a first user command selecting the user-defined view name; and
in response to the first user command, displaying the text box with the user-defined prompt displayed within the text box.

7. The method of claim 6, further comprising the steps of:
receiving a second user command selecting the default view name; and
in response to the second user command, displaying the text box with the pre-configured prompt displayed within the text box.

8. The method of claim 5, further comprising the step of performing the method of claim 5 during an uninterrupted user session.

9. A computer storage medium comprising computer-executable instructions for performing the method of claim 5.

10. An apparatus configured to perform the method of claim 8.

11. A method for receiving data through a user interface, comprising the steps of:
receiving user input activating a user display comprising a text box;
determining whether a user-defined prompt has been previously defined for the text box;
if a user-defined prompt has been previously defined for the text box; displaying the text box with the user-defined prompt displayed within the text box.

12. The method of claim 9, further comprising the step of, if a user-defined prompt has not been previously defined for the text box; displaying the text box with a pre-configured prompt displayed within the text box.

13. The method of claim 11, further comprising the step of performing the method of claim 11 during an uninterrupted user session.

14. A computer storage medium comprising computer-executable instructions for performing the method of claim 11.

15. An apparatus configured to perform the method of claim 13.

16. A method for receiving data through a user interface comprising a text box, comprising the steps of:
displaying a pre-configured prompt within the text box;
receiving input from a first user defining a first user-defined prompt;
storing the first user-defined prompt in a database;
receiving input from a second user defining a second user-defined prompt;
storing the second user-defined prompt in the database;
in response to receiving a command from the first user activating the text box, displaying the text box with the first user-defined prompt displayed within the text box; and
in response to receiving a command from the second user activating the text box, displaying the text box with the second user-defined prompt displayed within the text box.

17. The method of claim 16, further comprising the steps of:
receiving a command from a third user activating the text box;
determining that the third user has not defined a user-defined prompt for the text box; and
displaying the text box with the pre-configured prompt displayed within the text box.

18. The method of claim 16, further comprising the steps of:
displaying a view selection utility comprising a user-defined view name associated with the first user defined view and a default view name associated with the pre-configured prompt; and
receiving a user command selecting the user-defined view name.

19. The method of claim 16, further comprising the step of performing the method of claim 16 during an uninterrupted user session.

20. A computer storage medium comprising computer-executable instructions for performing the method of claim 16.

21. An apparatus configured to perform the method of claim 19.

22. A method for receiving data through a user interface comprising a text box, comprising the steps of:
displaying a pre-configured prompt within the text box;
receiving input defining a first user-defined prompt;
receiving input defining a first view name associated with the first user-defined prompt;
storing the first user-defined prompt in association with the first view name in a database;
receiving input defining a second user-defined prompt;
receiving input defining a second view name associated with the second user-defined prompt;
storing the second user-defined prompt in association with the second view name in the database;
receiving a command activating the text box;
displaying a view selection utility comprising the first and second user-defined view names;
receiving a command selecting the first view name; and
displaying the text box with the first user-defined prompt displayed within the text box.

23. The method of claim 18, further comprising the steps of:
receiving a command selecting the second view name; and
displaying the text box with the second user-defined prompt displayed within the text box.

24. The method of claim 18, further comprising the steps of:
displaying within the view selection utility a default view name associated with the preconfigured prompt;
receiving a command selecting the default view name; and
displaying the text box with the pre-configured prompt displayed within the text box.

25. The method of claim 22, further comprising the step of performing the method of claim 22 during an uninterrupted user session.

26. A computer storage medium comprising computer-executable instructions for performing the method of claim 25.

27. An apparatus configured to perform the method of claim 22.
